(19) United States
(12) Patent Application Publication
(10) Pub. No.: US 2012/0040204 A1
(43) Pub. Date: Feb. 16, 2012

(54) WALL FACING PANEL

(76) Inventor: Andrey Vilenovich Lyubomirskiy, Moscow (RU)

(21) Appl. No.: 13/138,822

(22) PCT Filed: Mar. 26, 2010
(86) PCT No.: PCT/RU2010/000138

§ 371 Date: Sep. 29, 2011

(30) Foreign Application Priority Data
Mar. 31, 2009 (RU) 2009111479

(51) Int. Cl. B32B 3/30; B32B 15/04; B32B 15/01

(52) U.S. Cl. 428/600; 428/172

(57) ABSTRACT

Use: This invention is for improvements in or relating to the design of wall facing panels with textured surface and can be used in products designed for both indoor and outdoor wall panelling.

Spirit of the Invention: In accordance with the first embodiment, the wall panel contains the base and the outer layer on the front face of which there are textured elements making up a design pattern featuring convex elements and/or concaves; the design pattern created by the said elements contains the convex elements with a maximum width of up to 25 mm across, and the concaves with a width of under 25 mm and a depth under 0.95 d where d is the thickness of sheet material; the textured design pattern is created in conformity with the condition where S_{conv./}S_{conc} 0.05-19.0 where S_{conv.} is the combined area of the convex elements, and S_{conc} is the combined area of the concaves; the base is made, for example, of metal and/or of chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene with the addition of silica sand or mineral fibres with the thickness d=0.2-25.0 mm, and the outer layer is made, for example, of stainless steel or aluminium alloy and/or an alloy of aluminium and zinc and/or titan and/or bimetal and/or composite material with the thickness d=0.02-3.0 and the depth of the relief of the outer layer 0.001-2.0 mm.

The textured design is made as follows:
with regular spacing of the convex elements and concaves on the front face of the panel, with random spacing of the convex elements and concaves, or with a mix of regular and random spacing of the convex elements and concaves on the front face of the panel.

This invention is for improvements in or relating to the design of wall facing panels with textured surface and can be used in products designed for both indoor and outdoor wall panelling.

There is the decorative panel [1] which has a metal base and a decorative element in the form of a stencilled printed design with a tin layer in between the metal base and the decorative element; the tin layer can be, for example, anodized coating applied to the metal base, and the area occupied by the decorative coating accounts for 50 percent of the base.

There is also the functional and decorative wall panel [2] consisting of a flat metal sheet base, which is fastened to the wall, affixed with fixture elements to the functional and decorative elements on the outer surface of the wall panel; of the decorative layer on the outer side of the wall panel fastened to the base; and of the elastic padding built into the inner side of the panel; the decorative layer is made of a sheet polymer material; the elastic padding is made of flexible sheet material; in the decorative layer and in the base there are apertures spaced at regular intervals from each other along the vertical and horizontal axes; the fixture elements for the functional and decorative elements have hold-down heads fixed to the inner side of the wall panel; the said apertures have a profile that allows for easy insertion of the head of the fixture element into the front side of the wall panel and for the hold-down of the fixture element by the said head from the inner side of the wall panel; the wall panel is divided into sections that are abutted closely to one another on their flanks during the assembly of the wall panel.

The undesirable feature of the prior art decorative panels [1,2] is their structural complexity caused by the fact that they are not single-layer.

There is the metallic wall panel which is a rectangular metal sheet with its edges deflected along the entire perimeter of the sheet, making an acute angle to its front side with a decorative relief; the decorative relief is made by the rectilinear and/or curvilinear elongated ledges (collars) created by high-pressure treatment of the sheet material and positioned symmetrically to the point of intersection of the diagonals of the front surface; and the height of the elongated ledges is more than the thickness of the metal sheet [3].

The undesirable feature of the aforesaid metallic wall panel is that it has low performance characteristics. Indeed, applying high-pressure treatment to the sheet material to create the decorative relief on the front surface of the panel with the height of the elongated ledges bigger than the thickness of the metal sheet puts tight restrictions on the thickness of the metal sheet and the mechanical properties of the material it is made of. To manufacture the prior art metallic wall panel, it is not possible to use high-performance metal sheets with a thickness of over 0.8 mm made of high-strength alloy steel with high anticorrosion properties and mechanical strength.

There is also the metallic wall panel [4] having a rectangular aluminium base, on the front face of which there are ledges made of natural stone granules glued to the base.

The undesirable features of the prior art engineering solution are the low durability of the metallic wall panel and its low performance indicators since the prior art engineering solution does not assure the high durability of the metallic wall panel.

Closest to the proposed technical solution in its technical spirit is the prior art metallic wall panel [5] which consists of a stainless-steel metal base with decorative elements on its front face; the decorative elements are made in the form of concaves on its front face filled with dye of appropriate colour either on a level with or no more than 0.14 mm above the front face level by the powder coating method.

The prior art technical solution is limited in its use due to the simplified fabrication technology (using the powder coating method for filling the concaves with dye either on an equal level with or up to a certain level) which makes it impossible to achieve high quality and create decorative designs on the product in a wide range of product indicators and ensure that the product possesses high consumer properties.

An object, which is realised through the implementation of the designed product, is to create a new type of wall panels.

The technical result obtained through the implementation of the designed product is the creation of a dirt-resistant vandal-proof wall panel which could preserve its consumer properties over a longer period of time.

An object, which is realised through the implementation of the designed product, is to create a new type of wall panels.

The technical result obtained through the implementation of the designed product is the creation of a dirt-resistant vandal-proof wall panel which could preserve its consumer properties over a longer period of time.

The said technical result is achieved, in accordance with the first embodiment of the provided design of the wall panel, which contains the base and the outer layer on the front face of which there are textured elements making up a design pattern featuring convex elements and/or concaves by the fact that the design pattern created by the said elements contains the convex elements with a maximum width of up to 25 mm across, and the concaves with a width of under 25 mm and a depth under 0.95 d where d is the thickness of sheet material; the textured design pattern is created in conformity with the condition where S_{conv./}S_{conc} 0.05-19.0 where S_{conv.} is the combined area of the convex elements, and S_{conc} is the combined area of the concaves; the base is made, for example, of metal and/or of chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene with the addition of silica sand or mineral fibres and the outer layer is made, for example, of stainless steel or aluminium alloy and/or an alloy of aluminium and zinc and/or titan and/or bimetal and/or composite material with the thickness d=0.01-5.0 and the depth of the relief of the outer layer 0.001-5.0 mm. Furthermore, the interlayer can be made of fire-proof materials, for example, of silicate cotton and/or glass cotton and/or concretes and/or sheet fibre concrete and/or asbestos cement materials and/or foam glass and/or fibrous and/or foam materials and other non-combustible materials, and of self-extinguishing materials.

The said technical result is achieved, in accordance with the second embodiment of the provided design of the wall panel, which contains the base and the outer layer on the front face of which there are textured elements making up a design pattern featuring convex elements and/or concaves by the fact that the design pattern created by the said elements contains the convex elements with a maximum width of up to 25 mm across, and the concaves with a width of under 25 mm and a depth under 0.95 d where d is the thickness of sheet material; the textured design pattern is created in conformity with the condition where S_{conv./}S_{conc} 0.05-19.0 where S_{conv.} is the combined area of the convex elements, and S_{conc} is the combined area of the concaves; the base is made, for example, of metal and/or of chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene with the addition of silica sand or mineral fibres and the outer layer is made, for example, of stainless steel or aluminium-base alloy and/or an alloy of aluminium and zinc and/or titan and/or bimetal and/or composite material with the thickness d=0.01-5.0 mm and the depth of the relief of the outer layer 0.001-3.0 mm. And the concaves of the relief are filled with hardened medium. Furthermore, the interlayer can be made of fire-proof materials, for example, of silicate cotton and/or glass cotton and/or concretes and/or sheet fibre concrete and/or asbestos cement materials and/or foam glass and/or fibrous and/or foam materials and other non-combustible materials, and of self-extinguishing materials.

Unlike in the first embodiment, the second embodiment of the wall panel involves the filling of the concaves of the relief with hardened medium.

In accordance with the second embodiment of the panel, the concaves in the decorative design are filled with hardened medium which is resistant to mechanical impact, temperature drop; polymers or composite material or dye or metal alloys can be used as hardened medium for filling the concaves of the relief.

In addition, in the second embodiment of the panel, the base is made of foam and/or fibrous sheet materials.

The said technical result is achieved, in accordance with the third embodiment of the provided design of the wall panel, which contains the base and the outer layer on the front face of which there are textured elements making up a design pattern featuring convex elements and/or concaves by the fact that the design pattern created by the said elements contains the convex elements with a maximum width of up to 25 mm across, and the concaves with a width of under 25 mm and a depth under 0.95 d where d is the thickness of sheet material; the textured design pattern is created in conformity with the condition where S_{conv./}S_{conc} 0.05-19.0 where S_{conv.} is the combined area of the convex elements, and S_{conc} is the combined area of the concaves; the base is made, for example, of metal and/or of chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene with the addition of silica sand or mineral fibres and the outer layer is made, for example, of stainless steel or aluminium-base alloy and/or an alloy of aluminium and zinc and/or titan and/or a copper-based alloy and/or bimetal and/or composite material with the thickness d=0.01-5.0 mm and the depth of the relief of the outer decorative layer within the range of 0.001-3.0 mm. And an interlayer is introduced between the base and the decorative layer; the interlayer is formed by the polymer-based hardened material; the outer decorative layer and the base are tightly bound together.

The third embodiment of the design of the wall panel is different from the first and the second embodiments by the fact that an interlayer is introduced between the base and the decorative layer; the interlayer if formed by the polymer-based hardened material; the outer decorative layer and the base are tightly bound together. The concaves in the textured design are filled with the hardened medium; the hardened medium is tightly bound to the concaves.

The said technical result, which is to expand the range of the operation indicators, is achieved in the provided wall panel via three surface texture options:the texture of the surface features regularly spaced convex elements and concaves on the front face of the panel which make up an ornament;

the texture of the surface features randomly spaced convex elements and concaves on the front face of the panel which make up a chaotic design pattern;

the texture of the surface is a mix of regularly and randomly spaced convex elements and concaves on the front face of the panel that make up a pattern that features groups of convex and concave elements positioned in between the elements of the ornament.

During the development of the wall panel design, it was experimentally deduced that the width and the depth of the ledges and cavities of the relief-textured design are of key importance for this type of wall panels.

The tests and the research have revealed that the minimum possible width that is desirable from the economic point of view is 0.01 mm. Further reduction of the width is not desirable because it is difficult for the human eye to discern such small objects. Furthermore, from the technological point of view, cavities with a width of less than 0.01 mm can be produced by applying such a costly technique as photolithography. The objects larger than 0.01 can be made by inexpensive techniques, like tampon printing.

The use of micro-relief with the said dimensions filled with dyed medium (dye, dyed composite) makes it possible to protect the aforesaid dyed medium in the relief cavities from the damage that solid bodies may cause. In this case, the metallic ledges encircling the polymer perform the protective function. The smaller the width of the cavity filled with the dyed medium is, the smaller the chances are that the dyed medium will be damaged in the process of use. Usually, in a city environment, vandals more frequently use metallic coins, lock keys, less frequently penknives, i.e. the things that every man has at his disposal in public places.

Below are the specifications of coins:
the ten-kopek coin has a diameter of 17.5 mm and a thickness of 1.1 mm; made from a copper-base alloy.
the fifty-kopek coin has a diameter of 19.4 mm and a thickness of 1.4 mm; made from a copper-base alloy.
the one-rouble coin has a diameter of 20.5 mm and a thickness of 1.3 mm, made from a steel-base alloy.
the two-rouble coin has a diameter of 23 mm and a thickness of 1.8 mm; made from a steel-base alloy.
the two-rouble coin has a diameter of 25 mm and a thickness of 1.8 mm; made from a steel-base alloy.

The analysis of the geometric dimensions and the materials used in the production of the coins shows that the small-denomination coins of 10 and 50 kopeks made from soft copper-base alloys will not cause considerable damage to the decorative coatings of the panels. Moreover, the small size of the coins will not allow a vandal, without devoting a considerable physical effort, to have a firm grip on the coin by his thumb and index finger to ensure a significant part of the coin protrudes from in between the fingers. However, a vandal can easily have a firm grip on the coins with denominations of 1, 2 and 5 roubles between his fingers, in particular the five-rouble coin which has a diameter of 25 mm and a thickness of 1.8 mm.

During the testing of the relief characteristics, experiments were conducted with textured-surface sheet materials; the textured surface featured convexes and concaves, with the concaves filled with polymer powder paints based on the epoxy resin [symbol] -20 with a curing temperature of around 200° C. in the oven for five minutes. The width of the cavities in the relief used in the test varied from 0.01 mm to 50 mm. The relief cavities were either fully or half filled with the hardened dye. The force applied to the coin was within the range of 5 to 10 kg. The generatrix of the coin had a knurled profile.

Taking into account that the dye has a certain hardness which depends on the chemical composition of the binding agent (epoxide, polyester, polyurethane), it is evident that the value of resistance to the process of cutting of the surface by the coin changes. Moreover, the composition of dyes often includes fillers such as glass micro powder which have a high hardness value. In addition, the fact was taken into consideration that not all vandals can scratch the surface of a panel by a blunt coin for a long time, because it requires a strenuous physical effort. There is a need to bear in mind that the force of cutting as a coin scratches the cavities of the decorative relief should be huge so as to “get” to the bottom of the dyed cavity (filled with a polymer or a composite).

Numerous experiments conducted with the five-rouble coin have revealed that the biggest permissible width of the relief is 25 mm.

In other words, the optimal width of the cavity filled with dye is within the range of 0.01 mm to 25 mm.

In addition, it should be noted that the wall panel has another important consumer feature, which is that scratches are unnoticeable.

During the course of tests, it has been shown that a scratch on the dyed metal becomes noticeable when there appears a sharp contrast between the dyed and the undamaged surface and the gleam of the bear metal surface. If as a result of an act of vandalism a gleam of bear metal becomes visible on the monotonously dyed surface, a man subconsciously understands that there is a scratch in that place. With a width of less than 25 mm such scratches will be fewer in number as their length is limited to the same 25 mm. If scratches do appear, these will not be lines but rather barely visible specks instead.

In addition, the coating itself is an interlacing (from the point of view of the observer who does not have the knowledge of the composition and structure of the coating) of dyed and non-dyed patches some of which have a certain colour. All other patches are gleams of the metal surface and, above all, stainless steel. For a lay observer without special optical tools, it would be difficult to discern whether a gleam comes from an non-dyed patch, a ledge of the decorative relief or from a small scratch in the relief cavity which appeared as a result of an act of vandalism.

With a width of the relief elements ranging between 0.01 mm to 25 mm, fingerprints become invisible as well; fingerprints are one of the most common causes of dirt smearing a polished surface.

With the given width of the relief, it is easy to clear it of dust and other types of dirt.

The following are the important factors that influence the depth of the relief:
the quality of the dyed relief filler to hide the metal surface (to ensure the metal surface does not shine through the layer of the dyed filler). During the course of tests, it has been found that you can use a flat layer of the coloured filler with a thickness of 20-1200 micron.
under the impact of sun rays and above all ultraviolet, the relief filler—the dye—becomes less thick due to the destruction of the colouring agent's molecules and sublimation of the results of destruction of macromolecules;
reducing the depth of the relief while preserving the performance characteristics of the wall panel makes it possible to reduce the thickness of the panel, which leads to a reduction of its cost due to the decrease in the mass of the material, simplification of the panel fabrication technology, and the fact that it becomes easier to fasten the panel to the wall;
the dimensions of the fillers of the dyed matter. It has been found in the course of tests that the depth of the relief should be between 2 to 4 times more than the diameter of the biggest particle of the filler.

Taken the aforementioned into account, a series of experiments was conducted which revealed that the relief depth must not exceed the value of 0.95 d where d stands for the thickness of sheet material.

The experiments to study the discernibility of scratches, fingerprints and to clean the surface have showed that a decorative design must be made in accordance with the following condition: S_{conv.}/S_{conc}=0.05-19.0 where S_{conv.} is the combined area of the convex elements, and S_{conc} is the combined area of the concaves, with the metal base having a thickness of d=0.02-5.0 mm.

The spirit of the invention of the provided wall facing panel is illustrated in the drawings:

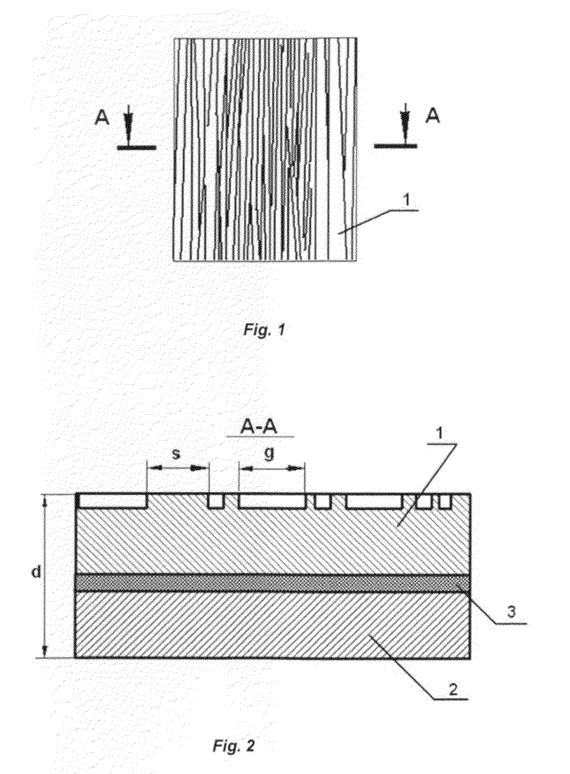

FIG. 1 shows a fragment of the front face of the metallic wall panel with randomly spaced linear textured elements with concaves unfilled with hardened material (embodiment 1, embodiment 3);

FIG. 2 shows a cross-section along the panel A-A with the outer decorative layer with concaves of the textured design pattern unfilled with hardened material, and the base (embodiment 2);

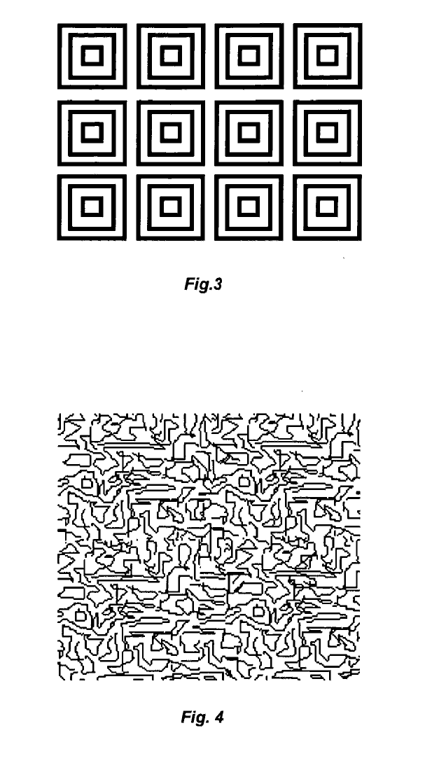

FIG. 3 shows a fragment of the front face of the metallic wall panel with a regularly spaced textured design with the concaves of the textured design unfilled with hardened material (embodiment 1, embodiment 3);

FIG. 4 shows a fragment of the front face of the metallic wall panel with a textured chaotic design pattern with the concaves of the textured design unfilled with hardened material (embodiment 1, embodiment 3);

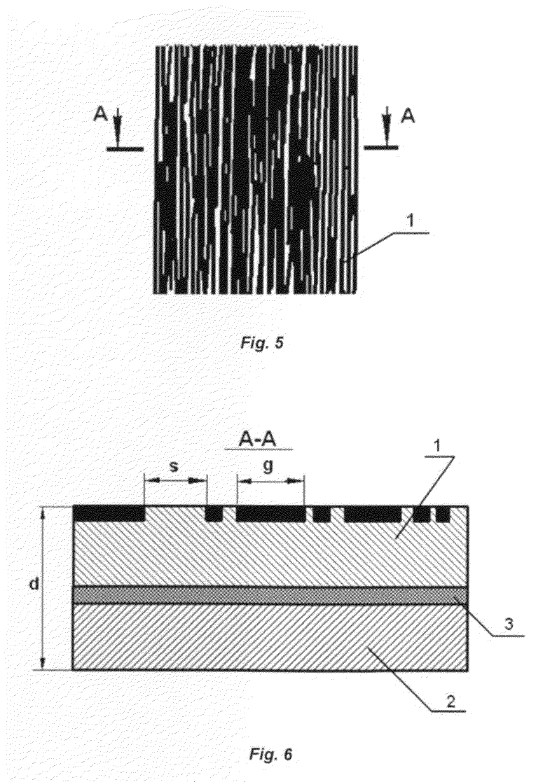

FIG. 5 shows a fragment of the front face of the metallic wall panel with randomly spaced linear textured elements with concaves filled with hardened material (embodiment 2, embodiment 3);

FIG. 6 shows a cross-section along the panel A-A with the concaves of the textured design filled with hardened material, and the base (embodiment 2);

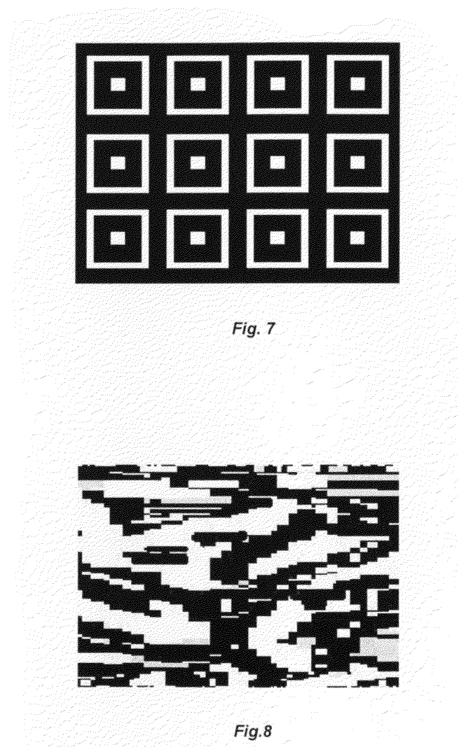

FIG. 7 shows a fragment of the front face of the metallic wall panel with regularly spaced textured elements with concaves of the textured design filled with hardened material (embodiment 2, embodiment 3);

FIG. 8 shows a fragment of the front face of the panel with randomly spaced linear textured elements and with concaves filled with hardened material (embodiment 2, embodiment 3);

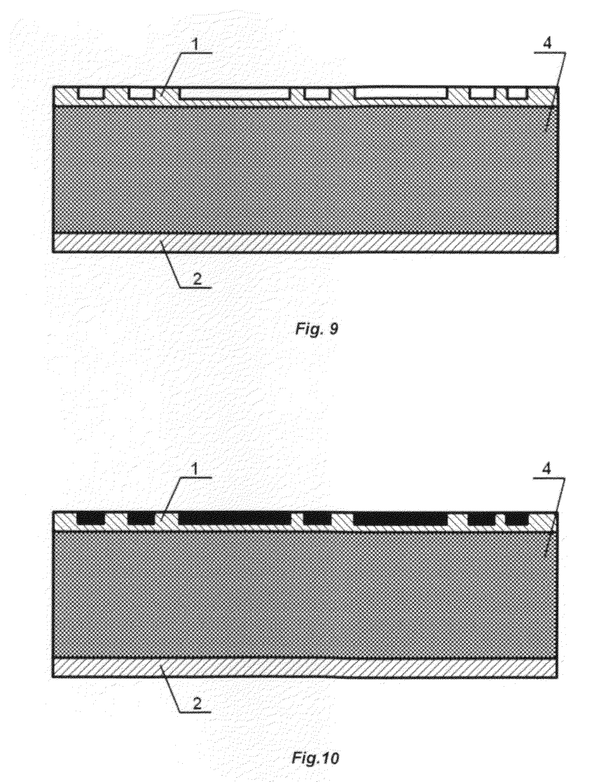

FIG. 9 shows the cross-section of the panel with the unfilled concaves of the textured design, the base and the interlayer made of foam (embodiment 3);

FIG. 10 shows the cross-section of the panel with the concaves of the textured design filled with hardened material, the base and the interlayer made of foam (embodiment 3);

The wall panel in accordance with the first embodiment (FIG. 1, FIG. 2) contains the decorative layer 1 made of sheet metal and the base 2 with the thin binding layer 3 in between them.

The textured design may be made in the form of randomly spaced linear elements (convex elements and concaves)—FIG. 1, textured elements spaced regularly across the surface of the decorative layer—FIG. 3, or the elements spaced chaotically across the surface of the decorative layer—FIG. 4.

In accordance with the embodiment 2, the concaves of the textured design are filled with hardened material, for example, with dye (FIG. 5, 6, 7, 8). The nature of the textured design may be the same as in the previous embodiment.

The design of the wall panel in accordance with the third embodiment is different from the previous two embodiments in that it contains the interlayer 4 made of foam (FIG. 9,10).

In all three embodiments of the design, the convex elements have the width size s from 0.1 mm to 25 mm and a depth not exceeding 0.95 d where d is the thickness of the sheet material of the decorative layer 1.

The given dimensions are caused by the following circumstances.

The experiments have showed that the maximum depth of 0.95 d guarantees the absence of etched apertures and the durability of the sheet material of the decorative layer 1.

The tests have showed that the width of the concaves s=0.01-25 mm makes it possible to ensure the wholeness of dye (if the concaves are filled with dye) or ensure the appearance of the necessary optical effects when reflecting the light falling on them (is the concaves are not filled with dye).

The decorative design is done in conformity with the condition S_{conv.}/S_{conc} 0.05-19.0 where S_{conv.} is the combined area of the convex elements, and S_{conc} is the combined area of the concaves.

The said ratios of the geometric parameters of the convex and concave elements make it possible to create relief designs (from simple designs and ornaments to complex drawing-type designs), thus making it possible to expand the area of use of the proposed wall facing panel.

The outer decorative layer 1 is made, for example, of stainless steel or aluminium alloy and/or an alloy of aluminium and zinc and/or titan and/or bimetal and/or composite material with the thickness d=0.01-5.0 mm and a depth of the relief of the outer decorative layer of 0.001-3.0 mm. The thickness of the decorative layer d-0.01 mm makes economic sense but requires consolidating the panel by the low-lying layers, and the thickness of more than 5.0 mm do make it economically worthwhile.

The base 2 is made of chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene and/or polyurethane and/or polysterol with the addition of silica sand or mineral fibres with the thickness d=0.01-5.0 mm.

The said materials, while being accessible and inexpensive provide the necessary mechanical solidity and durability of the fabricated wall panel.

In the first embodiment of the design of the wall panel the concaves are not filled with hardened material. The relief design on the outer layer is seen when directed light is focused on it. When using light rays of various colours there appears a certain “play” of the reflected light rays, which creates an artistic effect and attractiveness.

In the second embodiment of the design of the wall panel the concaves of the relief are filled with hardened medium (FIG. 5, 6, 7, 8).

Polymers or composite materials or dye are used as hardened medium filling the concaves of the relief.

This technical solution together with the decorative effect lend anti-vandal properties to the panel by ensuring the resilience of the front face to various types of mechanical impact, strikes, scratches, and the like.

The third embodiment of the design (FIG. 9, 10) features the interlayer 4 formed by the polymer-based hardened material which ensuring a tight binding of the outer decorative layer with the base, and the concaves of the decorative relief may be filled with hardened decorative component ensuing a tight binding with the surface of the concaves.

The provided wall panel is fabricated and operates in the following way.

The relief design with the said geometric parameters can be made on the outer decorative layer 1 by the method of chemical etching, for example; prior to etching, a protective mask must be applied using by template web printing technique and etching of the unprotected patches by the etching solution; as a result, a relief design is created in the metal tape with the concaves etched to the aforesaid value. The decorative design is done in conformity with the condition S_{conv.}/S_{conc} 0.05-19.0 where S_{conv.} is the combined area of the convex elements, and S_{conc} is the combined area of the concaves with the thickness d=0.01-5.0 mm.

The said ratios of the geometric parameters of the convex and concave elements make it possible to create relief designs of any degree of complexity (see FIG. 1, 3, 4).

Connection of the base 2 with the outer layer 1 can be done, for example, by means of gluing with the use of special adhesive compositions (FIG. 2,6).

After than the concaves of the relief design are filled with dye which subsequently hardens under the ultraviolet or infrared radiation.

Thus the design features distinguishing the provided wall panel from the prior art are dependent, through the relation of cause and effect, on the attainable technical result, which is the creation of a dirt-resistant vandal-proof wall panel which could preserve its consumer properties over a longer period of time.

The fastening of the panel to the surface that needs panelling is done by the prior art methods: the panels are glued to the surface (for example, a room wall) using an appropriate composition or fastened by fixture elements (not shown in the drawings).

The outer layer of the wall panel is to be fabricated from stainless steel (brands X18H25C2, X18H9, 08X18H10, 08X18H9T, 12X18H9, 12X18H9T, and others) or an aluminium alloy and/or an alloy of aluminium and zinc and/or bimetal and/or composite material with the thickness d=0.01-5.0 mm and a depth of the relief of the outer decorative layer 0.001-3.0.

The base 2 is made of accessible and cheap materials, for example, chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene and/or polyurethane and/or polysterol with the addition of silica sand or mineral fibres with the thickness d=0.2-25.0 mm.

The materials used in this wall panel are highly resistant to external impact, have anti-vandal protective properties and ensure a long operating life of the product.

### INFORMATION SOURCES

1. Patent of the Russian Federation No. 2780, IPC B44C 5/04, 1995.

2. Patent of the Russian Federation No. 54338, IPC B44F 5/00, 2006.

3. Patent of the Federal Republic of Germany No. 2903359, IPC B44F, B44C1980/04, 1980.

1-19. (canceled)

20. A wall panel, comprising a base and an outer layer on a front face of which there are textured elements with a design pattern including elements selected from the group consisting of convex elements, concaves and both, wherein the design pattern created by the said elements contains the convex elements with a maximum width of up to 25 mm across, and the concaves with a width of under 25 mm and a depth under 0.95 d where d is a thickness of sheet metal, the textured design pattern is created in conformity with a condition S_{conv./}S_{conc} 0.05-19.0 where S_{conv.} is a combined area of the convex elements, and S_{conc} is a combined area of the concaves; the base is composed of a material selected from the group consisting of metal, chipboard, fireboard, MDF, paper laminate, plywood, polymer material selected from the grove consisting of PolyVinylChloride, epoxide, polyester, polyurethane, polycarbonate, acryl, polystyrene and polyethylene, composite material with a hardened polymer based binding medium selected from the group consisting of glass-fiber plastic and coal plastic, polymers with mineral or layered fillers selected from the group consisting of polyethylene with addition of silica sand or mineral fibers; the outer layer is composed of a material selected from the group consisting of stainless steel, aluminum alloy, aluzinc, titan, bimetal and composite material with a thickness d=0.01-5.0 and a depth of a relief of the outer layer 0.001-3.0 mm.

21. The wall panel as defined in claim 20, wherein the design pattern has a regular spacing of the convex elements and concaves on the front face of the panel thus producing an ornament.

22. The wall panel as defined in claim 20, wherein the design pattern has a random spacing of the convex elements and concaves on the front face of the panel thus producing a chaotic design pattern.

23. The wall panel as defined in claim 19, wherein the design has a mix of regular and random spacing of the concaves and convex. elements on the front face of the panel, which forms the design pattern with groups of the convex elements and concaves positioned in between the elements of an ornament.

24. A wall panel, comprising the base and an outer layer composed of sheet metal on the front face of which there are textured elements with a design pattern including elements selected from the group consisting of convex elements, concaves and both, wherein the design pattern created by the elements contains the convex elements with a maximum width of up to 25 mm across, and the concaves with a width of under 25 mm and a depth under 095 d where d is a thickness of sheet material; the design pattern is created in conformity with a condition where S_{conv.}/S_{conc} 0.05-19.0 where S_{conv.} is a combined area of the convex elements, and S_{conc} is a combined area of the concaves; the base is composed of a material selected from the group consisting of metal, chipboard, fireboard, MDF, paper laminate, plywood and polymer material selected from a group consisting of PolyVinylChloride, epoxide, polyester, polyurethane, polycarbonate, acryl, polystyrene and polyethylene, a composite material with a hardened polymer-based binding medium selected from the group consisting of glass-fibre plastic and coal plastic, polymers with mineral or layered fillers and both, selected from the group consisting of polyethylene with addition of silica sand or mineral fibers with a thickness d=0.2-25.0 mm; and the outer layer is composed of a material selected from the group consisting of stainless steel, aluminum-base alloy, an alloy of aluminum and zinc, titan, copper-base alloy, bimetal, composite material with a thickness d=0.01-5.0 mm and a depth of a relief of the outer layer of 0.001 to 3.0 mm, and the concaves of the relief are filled with hardened medium.

25. The wall panel as defined in claim 24, wherein the concaves in the decorative design are filled with hardened medium resistant to mechanical impact and temperature drop.

26. The wall panel as defined in claim 25, wherein polymers are used as the hardened medium filling the concaves of the relief.

27. The wall panel as defined in claim 25, wherein composite material are used as the hardened material.

28. The wall panel as defined in claim 25, wherein dye is used as the hardened material.

29. The wall panel as defined in claim 23, wherein the base is composed of foam sheet materials.

30. The wall panel as defined in claim 24, wherein the design has regular spacing of the convex elements and concaves on the front face of the panel thus producing an ornament.

31. The wall panel as defined in claim 24, wherein the design has random spacing of the convex elements and concaves on the front face of the panel thus producing a chaotic design pattern.

32. The wall panel in claim 24, wherein the design has a mix of regular and random spacing of the concaves and convex elements on the front face of the panel, which forms a design pattern with groups of the convex elements and concaves positioned in between the elements of the ornament.

33. A wall panel comprising a base and an outer layer of sheet metal on a front face of which there are textured elements with a design pattern including elements selected from the group consisting of convex elements, concaves and both, wherein the design pattern created by the said elements contains the convex elements with a maximum width of up to 25 mm across, and the concaves with a width of under 25 mm and a depth under 0.95 d where d is a thickness of sheet material; the textured design pattern is created in conformity with a condition where S_{conv.}/S_{conc} 0.05-19.0 where S_{conv.} is a combined area of the convex elements, and S_{conc} is a combined area of the concaves; the base is composed of a material selected from the group consisting of metal, chipboard, fireboard, MDF, paper laminate, plywood, and a polymere material selected from the group consisting of PolyVinylChloride, epoxide, polyester, poltyurethane, polycarbonate, acryl, polystyrene and polyethylene, composite material with a hardened polymer-based binding medium selected from the group consisting of glass-fiber plastic and coal plastic, polymers with mineral or layered fillers selected from the group consisting of polyethylene with addition of silica sand and mineral fibers with a thickness d=0.2-25.0 mm, and the outer layer is composed of a material selected from the group consisting of stainless steel, aluminum-base alloy, an alloy of aluminum and zinc, titan, copper-base alloy, bimetal, composite material with a thickness d=0.01-5.0 mm and a depth of a relief of the outer decorative layer of 0.001 to 3.0 mm; an interlayer is formed by the polymer-based hardened material and a tight connection is provided between the outer decorative layer and the base.

34. The wall panel in claim 33, wherein the concaves in the textured design are filled with a hardened medium tightly bound to a surface of the concaves.

35. The wall panel in claim 33, wherein the design has regular spacing of the convex elements and concaves on the front face of the panel thus producing an ornament.

36. The wall panel in claim 33, wherein the design has random spacing of the convex elements and concaves on the front face of the panel thus producing a chaotic design pattern.

37. The wall panel in claim 33, wherein the design pattern has a mix of regular and random spacing of the concave and convex elements on the front face of the panel, with groups of the convex elements and concaves positioned in between the elements of an ornament.
